(19) United States
(12) Patent Application Publication
(10) Pub. No.: US 2010/0266303 A1
(43) Pub. Date: Oct. 21, 2010

(54) IMAGE FORMING APPARATUS AND IMAGE FORMING METHOD

(75) Inventors: Hirotaka Fukuyama, Shizuoka-ken (JP); Satoshi Itaya, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/761,725

(22) Filed: Apr. 16, 2010

Related U.S. Application Data
(60) Provisional application No. 61/170,913, filed on Apr. 20, 2009.

(51) Int. Cl. G03G 15/01

(52) U.S. Cl. 399/54

(57) ABSTRACT

According to one embodiment, an image forming apparatus configured to form an image and record the image on a recording material includes a driving unit configured to drive plural color developing devices and a black developing device independent from one another, a toner quantity meter configured to measure toner residual quantities in the developing devices after development processing applied to photoconductive members, a toner supplying unit configured to execute operation for supplying the toners to the respective developing devices according to the measured toner residual quantities, and a controller configured to start, with reference to timing when the toner supply operation is completed last in the plural color developing devices, operation for stopping the plural color developing devices and start, with reference to timing when the black toner supply operation is completed, operation for stopping the black developing device.

### CROSS-REFERENCE TO RELATED APPLICATION

This application is based upon and claims the benefit of U.S. Provisional Application No. 61/170,913, filed on Apr. 20, 2009; the entire contents of which are incorporated herein by reference.

### FIELD

Embodiments described herein relate generally to an image forming apparatus of a quadruple tandem type and an image forming method.

### BACKGROUND

An image forming apparatus of a quadruple tandem type in the past operates according to a procedure explained below. The image forming apparatus forms toner images respectively on the surfaces of photoconductive members for yellow (Y), magenta (M), cyan (C), and black and transfers the toner images on the photoconductive members onto an intermediate transfer member. The intermediate transfer member transfers the toner images onto a sheet. At timing when the sheet having the toner images transferred thereon passes a fixing device, the image forming apparatus starts last operation for supplying toners of Y, M, C, and BK in printing operation. At timing when the toner supply operation is completed last for Y, M, C, or BK, the image forming apparatus stops developing devices for Y, M, C, and BK and shifts to completion control.

### BRIEF DESCRIPTION OF THE DRAWINGS

FIG. 1 is an exemplary view showing an overall diagram of an image forming apparatus according to a first embodiment of the present invention;

FIG. 2 is an exemplary view showing a diagram for explaining the detailed configuration and the operation around a photoconductive member for a black (BK) toner in the image forming apparatus according to the first embodiment;

FIG. 3 is an exemplary view showing a time chart of on and off timing for driving signals and control signals in the image forming apparatus according to the first embodiment;

FIG. 4 is an exemplary view showing a diagram of the schematic configuration of a developing device;

FIG. 5 is an exemplary view showing a time chart representing toner empty determining operation;

FIG. 6 is an exemplary view showing a time chart representing toner empty determining operation in an image forming apparatus according to a second embodiment of the present invention; and

FIG. 7 is an exemplary view showing a diagram of forms of toner empty determining operation.

### DETAILED DESCRIPTION

In general, according to one embodiment, an image forming apparatus configured to form an image and record the image on a recording material, the image forming apparatus including: a driving unit configured to drive plural color developing devices and a black developing device independent from one another; a toner quantity meter configured to measure toner residual quantities in the developing devices after development processing applied to photoconductive members; a toner supplying unit configured to execute operation for supplying the toners to the respective developing devices according to the measured toner residual quantities; and a controller configured to start, with reference to timing when the toner supply operation is completed last in the plural color developing devices, operation for stopping the plural color developing devices and start, with reference to timing when the black toner supply operation is completed, operation for stopping the black developing device.

### First Embodiment

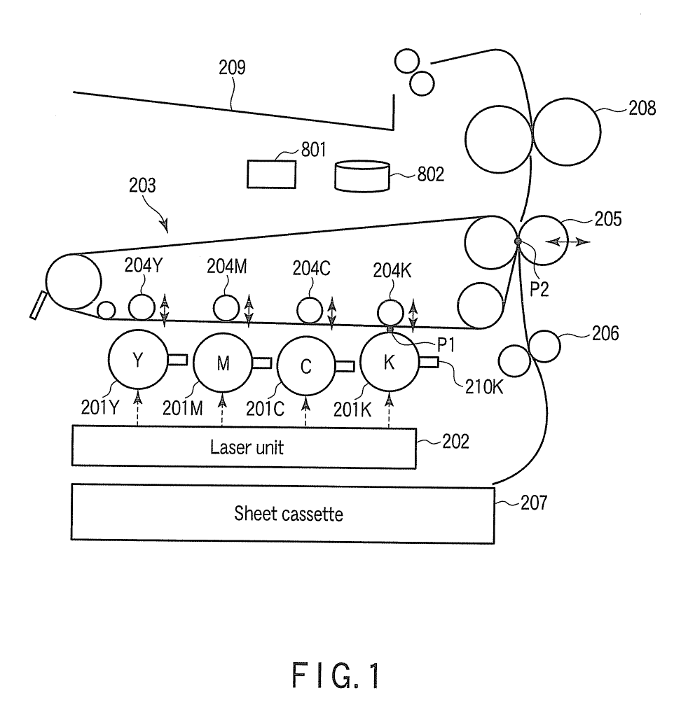

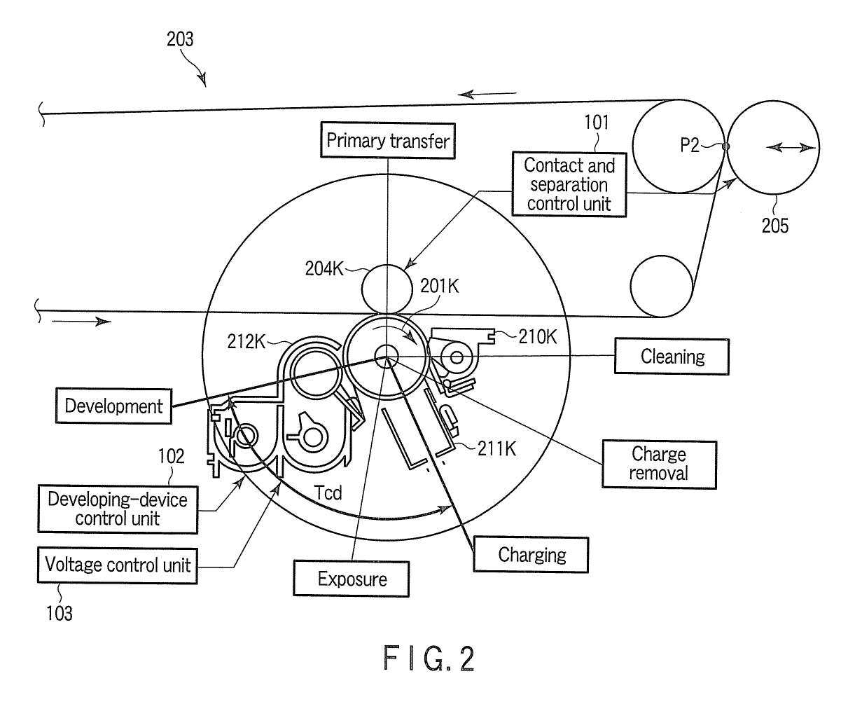

An image forming apparatus according to a first embodiment of the present invention is explained below with reference to the accompanying drawings. FIG. 1 is an overall diagram of the image forming apparatus. FIG. 2 is a diagram for explaining the detailed configuration and the operation around a photoconductive member 201K for a black (BK) toner in the image forming apparatus.

As shown in FIGS. 1 and 2, the image forming apparatus according to this embodiment is an electrophotographic recording apparatus of a quadruple tandem type. The image forming apparatus includes photoconductive members 201Y to 201K, a laser unit 202, a transfer belt 203, primary transfer rollers 204Y to 204K, a secondary transfer roller 205, a registration roller 206, a sheet cassette 207, a fixing device 208, a paper discharge tray 209, a contact and separation control unit 101, a developing-device control unit 102, a voltage control unit 103, a CPU 801, and a memory 802.

The CPU 801 collectively controls respective kinds of processing in the image forming apparatus. The CPU 801 executes computer programs stored in the memory 802 to thereby realize various functions of the image forming apparatus. The memory 802 includes, for example, a ROM or a RAM and stores, besides the computer programs, various kinds of information used in the image forming apparatus.

The contact and separation control unit 101 controls contact and separation operation for separating the transfer belt 203 and photoconductive members 201Y to 201K from each other and bringing the transfer belt 203 and the photoconductive members 201Y to 201K into contact with each other. The contact and separation control unit 101 also controls contact and separation operation for separating the transfer belt 203 and the secondary transfer roller 205 from each other and bringing the transfer belt 203 and the secondary transfer roller 205 into contact with each other. The developing-device control unit 102 controls toner supply operation in developing devices respectively arranged along photoconductive surfaces of the photoconductive members 201Y to 201K. The voltage control unit 103 controls so-called transfer bias.

Image forming operation in the image forming apparatus according to this embodiment is explained below. Although operation for the photoconductive member 201K is explained, the operation is the same for the other photoconductive members 201Y to 2010.

When image formation processing is started, a cleaner 210K cleans the photoconductive surface of the photoconductive member 201K that starts rotation. Subsequently, after the photoconductive surface of the photoconductive member 201K is subjected to charge removal processing, a charger 211K performs charging processing for the photoconductive surface. The laser unit 202 applies, on the basis of image data, exposure processing to an area of the photoconductive surface of the photoconductive member 201K subjected to the charging processing and forms an electrostatic latent image on the photoconductive surface. A developing device 212K visualizes the electrostatic latent image with a two-component developer including a toner and a carrier.

The transfer belt 203 comes into contact with and separates from the photoconductive member 201K according to the movement of the primary transfer roller 204K. A toner image visualized on the photoconductive member 201K is transferred from the photoconductive surface onto a belt surface of the transfer belt 203 in a predetermined transfer position P1 when the transfer belt 203 comes into contact with the photoconductive member 201K. Similarly, toner images of the respective colors are transferred onto the transfer belt 203.

The secondary transfer roller 205 is arranged to be capable of coming into contact with and separating from the belt surface of the transfer belt 203. A sheet conveyed from the sheet cassette 207 is pressed against the belt surface by the secondary transfer roller 205 in a predetermined secondary transfer position P2. The toner images are transferred onto the sheet.

The fixing device 208 heats and fixes the toner images transferred onto the sheet. The sheet is discharged to the paper discharge tray 209.

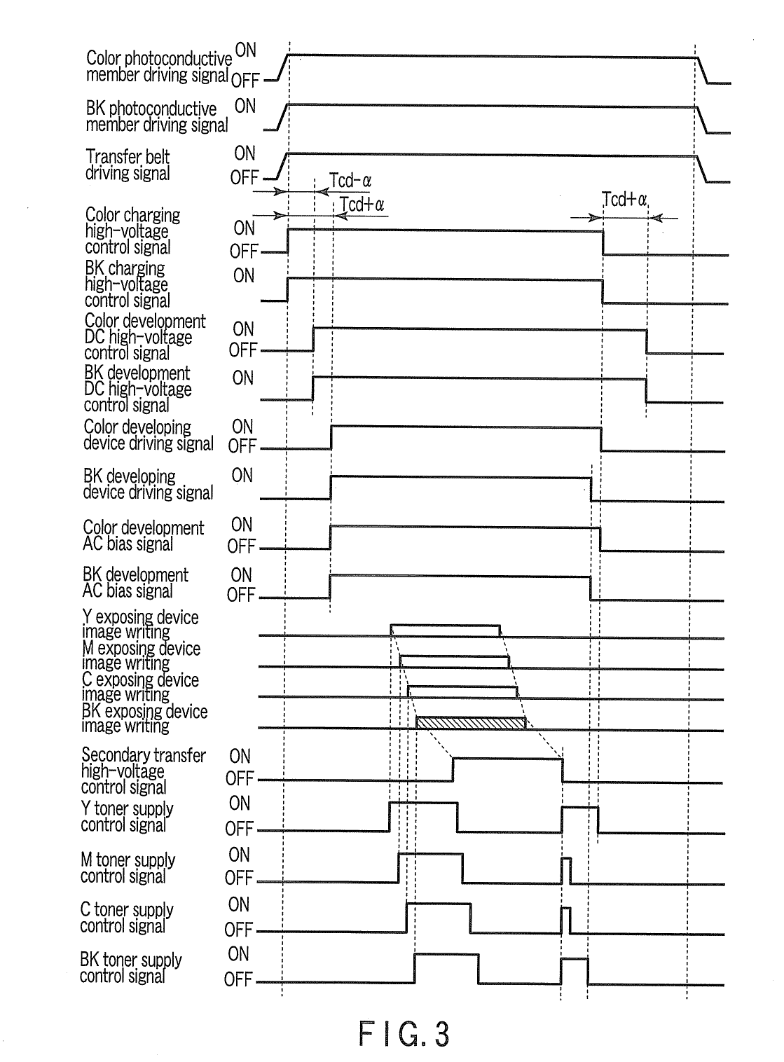

FIG. 3 is a time chart of on and off timing for driving signals and control signals in the image forming apparatus according to this embodiment. The image forming apparatus according to this embodiment has signals of two systems, i.e., signals for driving and controlling members related to colors (Y, M, and C) and signals for driving and controlling members related to black (BK).

Prior to the start of charging processing by color and BK chargers 211, the image forming apparatus starts rotation driving of the color and BK photoconductive members 201 and driving of the transfer belt 203. The image forming apparatus starts so-called high-voltage charging, which is the charging processing by the color and BK chargers 211, at timing when the rotation of the color and BK photoconductive members 201 is stabilized.

For development processing in the color and BK developing devices 212, timing for applying development high voltage for the colors and BK, which is a predetermined potential difference, is advanced by margin distance equivalent time (a) from moving time Tcd until movement to a development position from the start of the charging processing for the photoconductive surfaces of the color and BK photoconductive members 201. The image forming apparatus starts rotation driving of mug rollers incorporated in the color and BK developing devices 212, which represents the start of toner supply operation in the developing devices 212, at timing delayed by the margin distance equivalent time (α) from the moving time Tcd until the movement to the development position from the start of the charging processing for the photoconductive surfaces of the color and BK photoconductive members 201. The moving time Tcd is shown in FIG. 2.

Subsequently, image writing on the photoconductive members 201Y to 201K is performed by the laser unit 202. Electrostatic latent images on the photoconductive members 201Y to 201K are visualized by the developing devices 212Y to 212K and toner images of the respective colors are transferred onto the transfer belt 203. Secondary transfer high voltage is applied to the secondary transfer roller 205 in advance, whereby the toner images on the transfer belt 203 is transferred onto a sheet in the predetermined secondary transfer position P2.

Last toner quantity measurement in the printing operation is performed as explained below. In a period until the sheet having the toner images transferred thereon passes through the fixing device 208 after passing through the secondary transfer roller 205, quantities of the toners in the developing devices 212Y to 212K for the respective colors are measured by a toner specific concentration sensor.

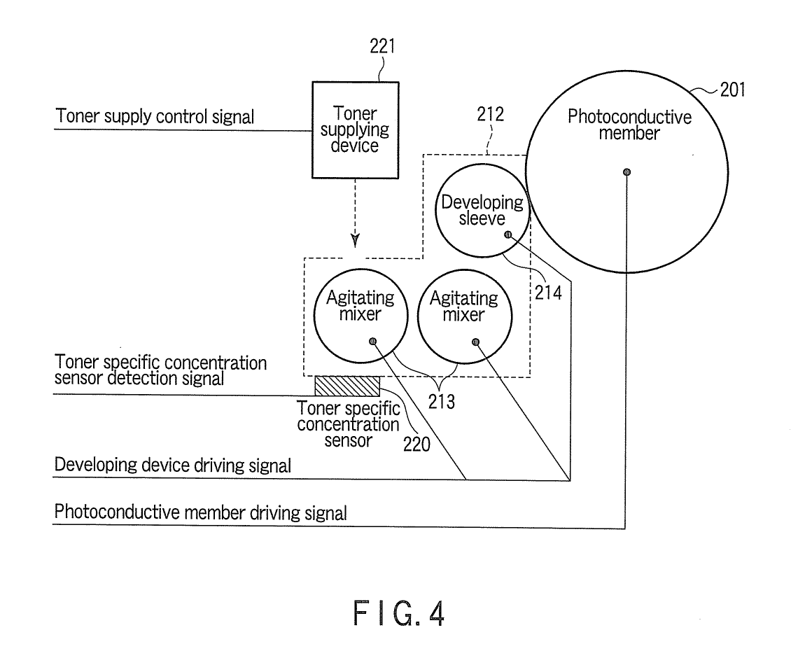

FIG. 4 is a diagram of the schematic configuration of the developing device 212. The developing device 212 includes agitating mixers 213 and a developing sleeve 214. The agitating mixers 213 agitate a toner supplied from a toner supplying device 221 and supply the toner to the photoconductive member 201 via the developing sleeve 214. Developing bias is applied to the developing sleeve 214. An electrostatic latent image on the photoconductive member 201 is developed into a toner image according to reversal development.

A toner specific concentration sensor 220 configured to detect toner specific concentration in a developer container is provided in the developing device 212. The toner specific concentration sensor 220 outputs a measurement signal corresponding to a toner residual quantity in the developer container. Therefore, the toner supplying device 221 is controlled according to the output from the toner specific concentration sensor 220 to supply the toner into the developer container. Specifically, the toner is supplied from the toner supplying device 221 into the developer container according to a toner supply control signal for time corresponding to the measurement signal of the toner specific concentration sensor 220 representing the toner residual quantity.

In this embodiment, since a two-component developer as a mixture of a toner and a magnetic carrier is used, it is possible to measure a toner residual quantity in the developer container using the toner specific concentration sensor 220. Therefore, when a general developer is used, a sensor that can measure a toner level and a toner residual quantity in the developer container is used.

In the time chart shown in FIG. 3, toner supply signals for the respective colors are turned on at timing when a secondary transfer high-voltage control signal is turned off. Supply of toners into developer containers is started.

As explained above, the image forming apparatus according to this embodiment has two developing device driving signals, i.e., the driving signal for the BK developing device and the driving signal for the color developing devices. Therefore, at timing when a BK toner supply control signal is turned off, the BK developing device driving signal is turned off to stop the supply of the BK toner and a BK development AC bias signal is turned off.

At timing when any one of color (Y, M, and C) toner supply control signals is turned off last, the color developing device driving signal is turned off and a color development AC bias signal is turned off. In an example shown in FIG. 3, since the Y toner supply control signal is turned off last, the color developing device driving signal and the color development AC bias signal are turned off at timing when the Y toner supply control signal is turned off.

On the other hand, both charging high-voltage control signals by the color and BK chargers 211 are turned off at the off timing of the Y toner supply control signal turned off last. A developing high-voltage applied state in the color and BK developing devices 212 are completed with a further delay of the margin distance equivalent time (a) from the moving time Tcd. Thereafter, the rotation driving of the color and BK photoconductive members and the transfer belt driving are stopped.

Usually, the printing operation is completed as explained above. However, when it is highly likely that a toner cartridge is empty, the image forming apparatus executes toner empty determining operation.

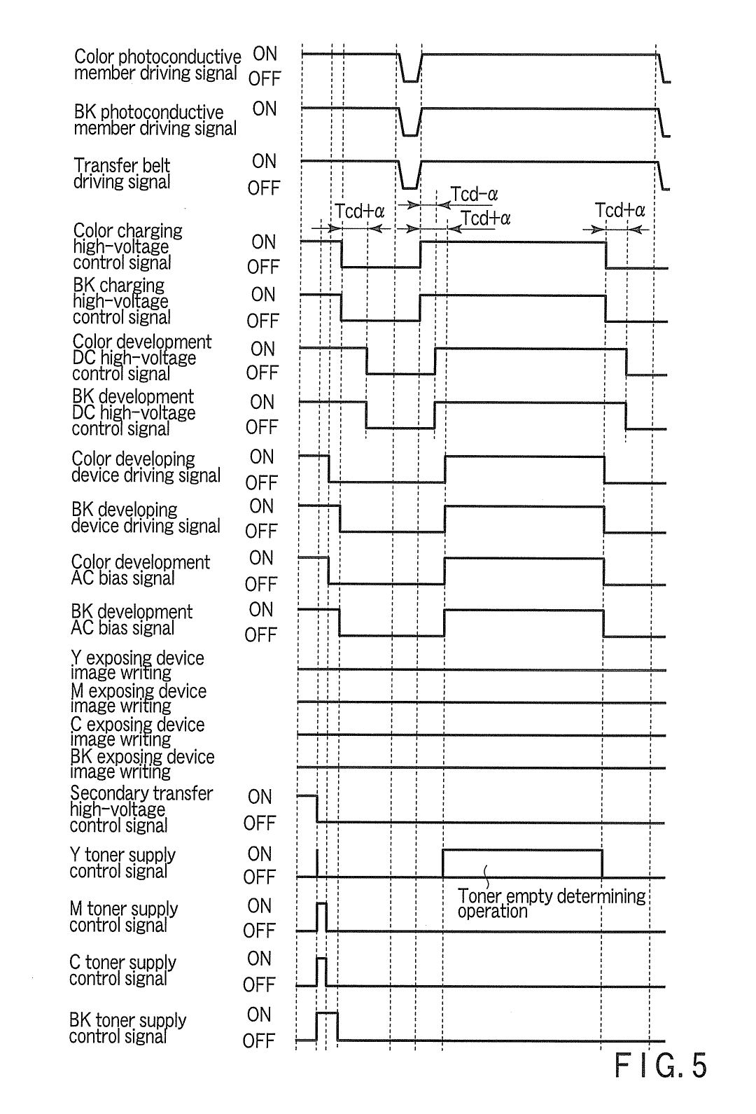

FIG. 5 is a time chart representing the toner empty determining operation.

If a toner cartridge is empty or if a toner is not supplied to the toner cartridge because of some cause, a quantity of a toner in a developer container does not increase even if a toner supply control signal is turned on and, thereafter, decreases every time printing is performed. In the time chart shown in FIG. 5, the toner empty determining operation is performed when a residual quantity of the Y toner in a color developer container is very small.

In FIG. 5, if a measurement value of the toner specific concentration sensor for the Y developing device 212Y falls below a predetermined level, the image forming apparatus does not execute toner supply operation for the Y developing device 212Y. Specifically, the image forming apparatus executes toner supply operation for the other colors and, when the supply operation is completed, once stops the image forming operation. Operation for completing the toner supply operation and operation for completing the printing operation are the same as those explained with reference to FIG. 3.

After stopping the driving of the color and BK photoconductive members 201 and the driving of the transfer belt 203, the image forming apparatus immediately restarts. When restarting, as in the operations explained with reference to FIG. 3, the image forming apparatus executes both the operations for the colors and BK. However, the image forming apparatus does not perform exposure operation by the laser unit 202. At timing same as the timing for the rotation driving of the mug rollers incorporated in the color and BK developing devices 212 and the application of the developing bias, the image forming apparatus executes the toner empty determining operation for the Y developing device 212Y. In the toner empty determining operation, the image forming apparatus determines whether a toner cartridge is empty and performs processing corresponding to a result of the determination.

At timing when the toner empty determining operation is completed, the image forming apparatus turns off the color and BK charging high-voltage control signals, the color and BK developing device driving signals, and the color and BK development AC bias signals. The image forming apparatus turns off color and BK development DC high-voltage signals with a delay of the margin distance equivalent time (α) from the moving time Tcd. Thereafter, the image forming apparatus stops the rotation driving of the color and BK photoconductive members and the transfer belt driving.

With the image forming apparatus according to the first embodiment explained above, effects explained below are realized.

(1) The image forming apparatus in the past integrally drives the color and BK developing devices 212. At the timing when the toner supply operation for any one of Y, M, C, and BK is completed last, the image forming apparatus stops the driving of the Y, M, C, and BK developing devices and shifts to the printing operation completing procedure.

On the other hand, the image forming apparatus according to this embodiment independently drives the color and BK developing devices 212. Therefore, the color developing devices are stopped with reference to the timing when the toner supply operation for any one of the color developing devices is completed last. The BK developing device is stopped with reference to the timing when the BK toner supply operation is completed. As a result, it is possible to reduce time for agitation driving for the toners by the agitating mixers and time for bias voltage application and realize extension of the life of the developers.

(2) The image forming apparatus in the past starts the operation for detecting a toner residual quantity at the timing when the sheet is discharged from the fixing device 208. The image forming apparatus according to this embodiment measures, with the toner specific concentration sensor, quantities of the toners in the developing devices for the respective colors earlier than the timing of the image forming apparatus in the past and in a period until the sheet passes through the fixing device 208 after passing through the secondary transfer roller 205. The image forming apparatus starts the toner supply operation according to a result of the measurement. As a result, since the toner supply is completed early, it is possible to reduce the time for the agitation driving for the toners by the agitating mixers and realize extension of the life of the developers.

### Second Embodiment

In a second embodiment of the present invention, toner empty determining operation is different from that in the first embodiment. Components same as those in the first embodiment are denoted by the same reference numerals and signs and detailed explanation of the components is omitted.

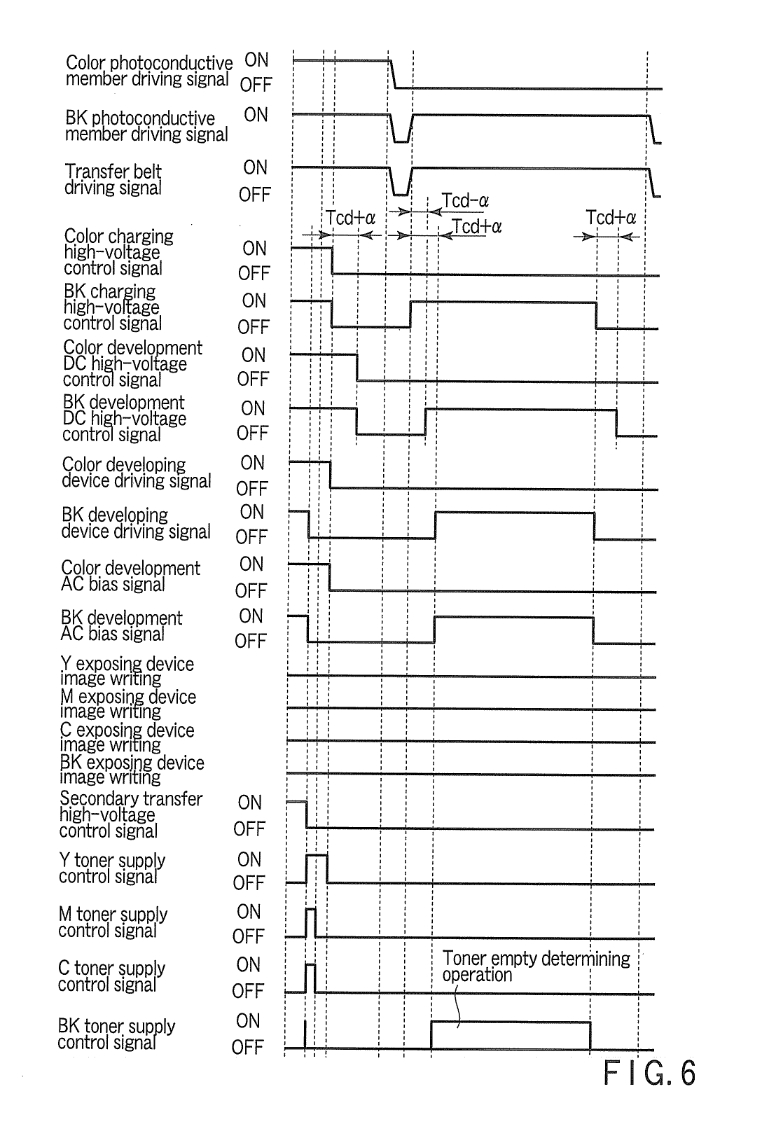

FIG. 6 is a time chart representing the toner empty determining operation in an image forming apparatus according to the second embodiment. In the time chart shown in FIG. 6, the toner empty determining operation is performed when a residual quantity of the BK toner in the BK developer container is very small.

If, judging from a measurement value of the toner specific concentration sensor for the BK developing device 212K, the toner residual quantity falls below a predetermined level, the image forming apparatus does not execute toner supply operation for the BK developing device 212K. Specifically, the image forming apparatus executes toner supply operation for the other colors and, when the supply operation is completed, once stops the operation. Operation for completing the toner supply operation and operation for completing the printing operation are the same as those explained with reference to FIG. 3.

After stopping the driving of the color and BK photoconductive members 201 and the driving of the transfer belt 203, the image forming apparatus immediately restarts. When restarting, the image forming apparatus executes operation only for BK. The image forming apparatus does not perform exposure operation by the laser unit 202. At timing same as the timing for the rotation driving of the mug roller incorporated in the BK developing device 212K and the application of the developing bias, the image forming apparatus executes the toner empty determining operation for the BK developing device 212K. In the toner empty determining operation, the image forming apparatus determines whether a toner cartridge is empty and performs processing corresponding to a result of the determination.

At timing when the toner empty determining operation is completed, the image forming apparatus turns off the charging high-voltage control signal, the developing device driving signal, and the development AC bias signal by the BK charger 211K. The image forming apparatus turns off a BK development DC high-voltage signal with a delay of the margin distance equivalent time (a) from the moving time Tcd. Thereafter, the image forming apparatus stops the rotation driving of the BK photoconductive member 201 and the driving of the transfer belt 203.

With the image forming apparatus according to the second embodiment explained above, when restarting, the image forming apparatus starts only the sections related to the operation for BK. Therefore, in addition to the effects explained in the first embodiment, it is possible to reduce time for agitation driving by the agitating mixers of the color developing devices 212 and realize extension of the life of the color developers.

In the second embodiment, if it is detected that a toner residual quantity is at a level for shifting to the toner empty determining operation for the BK developing device 212K, the image forming apparatus restarts only the sections related to the operation for BK. This operation may also be applied to the colors. Specifically, if it is detected that a toner residual quantity is at a level for shifting to the toner empty determining operation for any one of the color developing devices for Y, M, and C, the image forming apparatus can restart only the sections related to the operation for Y, M, and C without restarting the sections related to the operation for BK.

The toner empty determining operation in the first embodiment and the toner empty determining operation in the second embodiment can be combined as appropriate.

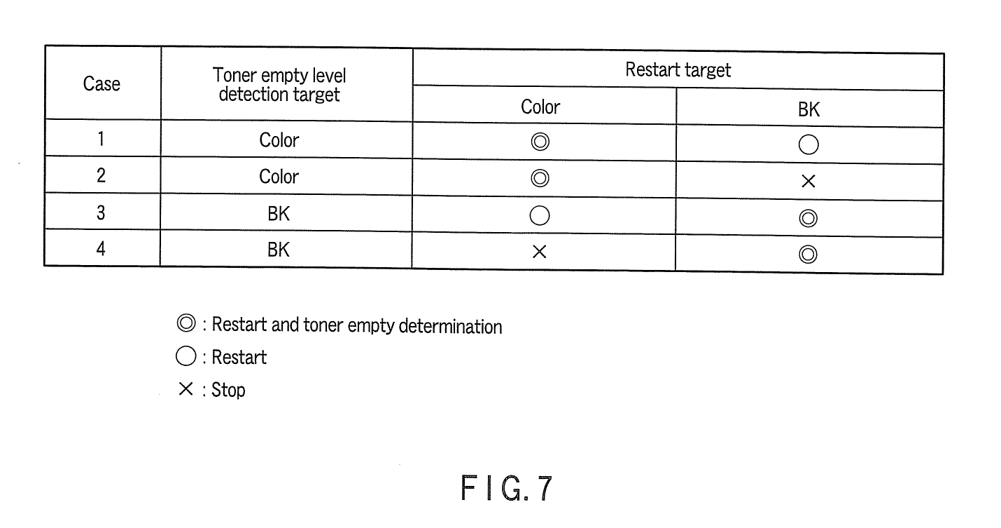

FIG. 7 is a diagram of forms of the toner empty determining operation. In the figure, the forms are classified into four cases according to whether a section detected as being at a level for shifting to the toner empty determining operation is a section for the colors or a section for BK or whether a section to be restarted is a section for the colors or a section for BK. In FIG. 7, a double circle indicates that the restart and the toner empty determining operation are performed. A circle indicates that the restart is performed. A cross indicates that the restart is not performed and the stop state is maintained.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image forming apparatus configured to form an image and record the image on a recording material, the image forming apparatus comprising:
a driving unit configured to drive plural color developing devices and a black developing device independent from one another;
a toner quantity meter configured to measure toner residual quantities in the developing devices after development processing applied to photoconductive members;
a toner supplying unit configured to execute operation for supplying the toners to the respective developing devices according to the measured toner residual quantities; and
a controller configured to start, with reference to timing when the toner supply operation is completed last in the plural color developing devices, operation for stopping the plural color developing devices and start, with reference to timing when the black toner supply operation is completed, operation for stopping the black developing device.

2. The apparatus according to claim 1, further comprising a toner-empty determining unit configured to prohibit the toner supply operation for the developing device in which the measured toner residual quantity is equal to or smaller than a predetermined value, restart the apparatus after completing the operation of the apparatus, and determine whether the developing device in which the toner residual quantity is equal to or smaller than the predetermined value is empty of toner.

3. The apparatus according to claim 2, wherein the toner-empty determining unit prohibits the start of the plural color developing devices in the restart if the developing device in which the toner residual quantity is equal to or smaller than the predetermined value is the black developing device.

4. The apparatus according to claim 2, wherein the toner-empty determining unit prohibits the start of the black developing device in the restart if the developing device in which the toner residual quantity is equal to or smaller than the predetermined value is any one of the color developing devices.

5. The apparatus according to claim 1, wherein the image forming apparatus starts last measurement of a toner residual quantity by the toner quantity meter in printing operation in a period from time when the formed image is transferred onto the recording material until fixing of the image is completed.

6. The apparatus according to claim 5, further comprising a toner-empty determining unit configured to prohibit the toner supply operation for the developing device in which the measured toner residual quantity is equal to or smaller than a predetermined value, restart the apparatus after completing the operation of the apparatus, and determine whether the developing device in which the toner residual quantity is equal to or smaller than the predetermined value is empty of toner.

7. The apparatus according to claim 6, wherein the toner-empty determining unit prohibits the start of the plural color developing devices in the restart if the developing device in which the toner residual quantity is equal to or smaller than the predetermined value is the black developing device.

8. The apparatus according to claim 6, wherein the toner-empty determining unit prohibits the start of the black developing device in the restart if the developing device in which the toner residual quantity is equal to or smaller than the predetermined value is any one of the color developing devices.

9. The apparatus according to claim 1, wherein
each of the toners is a two-component developer including a magnetic carrier, and
the toner quantity meter is a sensor configured to measure toner specific concentration.

10. The apparatus according to claim 1, wherein the toner supplying unit supplies the toners in a period of time corresponding to the measured toner residual quantity.

11. An image forming method for an image forming apparatus including a driving unit configured to drive plural color developing devices and a black developing device independently from one another, the image forming apparatus being configured to form an image and record the image on a recording material, the image forming method comprising:
measuring toner residual quantities in the developing devices after development processing applied to photoconductive members;
executing operation for supplying the toners to the respective developing devices according to the measured toner residual quantities;
starting, with reference to timing when the toner supply operation is completed last in the plural color developing devices, operation for stopping the plural color developing devices; and
starting, with reference to timing when the black toner supply operation is completed, operation for stopping the black developing device.

12. The method according to claim 11, further comprising:
prohibiting the toner supply operation for the developing device in which the measured toner residual quantity is equal to or smaller than a predetermined value;
restarting the image forming apparatus after completing the operation of the image forming apparatus; and
determining whether the developing device in which the toner residual quantity is equal to or smaller than the predetermined value is empty of toner.

13. The method according to claim 12, wherein the determination of toner empty includes prohibiting the start of the plural color developing devices in the restart if the developing device in which the toner residual quantity is equal to or smaller than the predetermined value is the black developing device.

14. The method according to claim 12, wherein the determination of toner empty includes prohibiting the start of the black developing device in the restart if the developing device in which the toner residual quantity is equal to or smaller than the predetermined value is any one of the color developing devices.

15. The method according to claim 11, further comprising starting last measurement of a toner residual quantity in printing operation in a period from time when the formed image is transferred onto the recording material until fixing of the image is completed.

16. The method according to claim 15, further comprising:
prohibiting the toner supply operation for the developing device in which the measured toner residual quantity is equal to or smaller than a predetermined value;
restarting the image forming apparatus after completing the operation of the image forming apparatus; and
determining whether the developing device in which the toner residual quantity is equal to or smaller than the predetermined value is empty of toner.

17. The method according to claim 16, wherein the determination of toner empty includes prohibiting the start of the plural color developing devices in the restart if the developing device in which the toner residual quantity is equal to or smaller than the predetermined value is the black developing device.

18. The method according to claim 16, wherein the determination of toner empty includes prohibiting the start of the black developing device in the restart if the developing device in which the toner residual quantity is equal to or smaller than the predetermined value is any one of the color developing devices.

19. The method according to claim 11, wherein
each of the toners is a two-component developer including a magnetic carrier, and
the measurement of the toner residual quantity includes measuring the toner residual quantity using a sensor configured to measure toner specific concentration.

20. The method according to claim 11, wherein the execution of the toner supply operation includes supplying the toners in a period of time corresponding to the measured toner residual quantity.
